(19) United States
(12) Patent Application Publication
(10) Pub. No.: US 2020/0056984 A1
(43) Pub. Date: Feb. 20, 2020

(54) OPTICAL MEASURING DEVICE

(71) Applicant: NATIONAL TSING HUA UNIVERSITY, Hsinchu (TW)

(72) Inventors: Lih-Yuan LIN, Hsinchu (TW); Po-Jui CHEN, Hsinchu City (TW)

(21) Appl. No.: 16/409,891

(22) Filed: May 13, 2019

(30) Foreign Application Priority Data
Aug. 15, 2018 (TW) 107128499

(51) Int. Cl. G01N 21/01; G01N 21/59; G01N 21/78

(52) U.S. Cl. CPC G01N 21/01; G01N 21/78; G01N 21/59

(57) ABSTRACT

An optical measuring device includes a light source, an optical sensing module, a positioning frame, a carrier, and a linking device. The optical sensing module includes a plurality of optical sensors. The light source and the optical sensing module are relatively disposed on the positioning frame. The carrier includes a plurality of hole rows, and the hole rows are arranged along a predetermined direction. Each of the hole rows includes a plurality of containing concaves for containing a measured object. The linking device is connected to the positioning frame and for driving the light source and the optical sensing module to move along the predetermined direction. The light source emits a light toward a side of the carrier, the light passes through the containing concaves to form a plurality of measured lights, and each of the optical sensors receives each of the measured lights.

### RELATED APPLICATIONS

This application claims priority to Taiwan Application Serial Number 107128499, filed Aug. 15, 2018, which is herein incorporated by reference.

### BACKGROUND

### Technical Field

The present disclosure relates to an optical measuring device.

### Description of Related Art

Optical measuring devices are used in many industrial applications nowadays. Through the optical characteristics of different objects, with the light source of appropriate wavelength and optical components, structure characteristics or reaction characteristics can be obtained from measured samples and properties can be further analyzed from the measured samples.

It has been found on the market that specific samples can be detected by conventional halogen lamps with optical filters through outputting specific wavelength of the light source. However, it is limited by the short lives of the conventional halogen lamps and the high cost of the optical filters, and it costs a lot. Furthermore, only one sample can be measured once by the conventional optical sensing devices, and the efficiency of measurement is subjected to tests.

### SUMMARY

According to one aspect of the present disclosure, an optical measuring device includes a light source, an optical sensing module, a positioning frame, a carrier, and a linking device. The optical sensing module includes a plurality of optical sensors. The light source and the optical sensing module are relatively disposed on the positioning frame. The carrier includes a plurality of hole rows, and the hole rows are arranged along a predetermined direction. Each of the hole rows includes a plurality of containing concaves for containing a measured object. The linking device is connected to the positioning frame and for driving the light source and the optical sensing module to move along the predetermined direction. The light source emits a light toward a side of the carrier, the light passes through the containing concaves to form a plurality of measured lights, and each of the optical sensors receives each of the measured lights.

### BRIEF DESCRIPTION OF THE DRAWINGS

The present disclosure can be more fully understood by reading the following detailed description of the embodiment, with reference made to the accompanying drawings as follows:

FIG. 1 is an appearance schematic view of an optical measuring device according to an embodiment of the present disclosure.

FIG. 2 is an exploded view of the optical measuring device according to the embodiment of FIG. 1.

FIG. 3 is an exploded view of the light source according to the embodiment of FIG. 1.

FIG. 4 is a schematic view of the light source, the optical sensing module and the positioning frame according to the embodiment of FIG. 2.

FIG. 5 is a schematic view of the carrier according to the embodiment of FIG. 2.

FIG. 6 is a system block diagram of the optical measuring device according to the embodiment of FIG. 2.

FIG. 7 is an appearance schematic view of an optical measuring device according to another embodiment of the present disclosure.

FIG. 8 is an exploded view of the optical measuring device according to the embodiment of FIG. 7.

### DETAILED DESCRIPTION

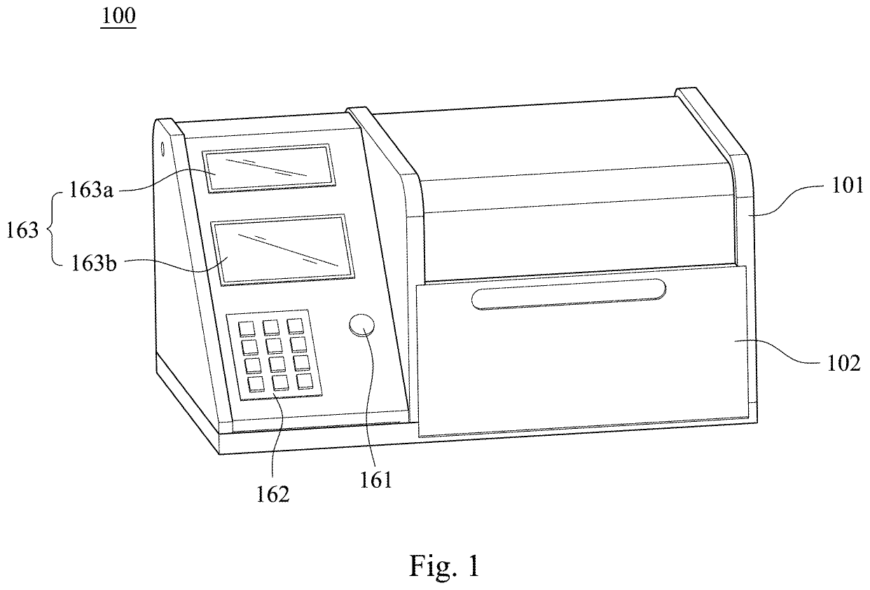

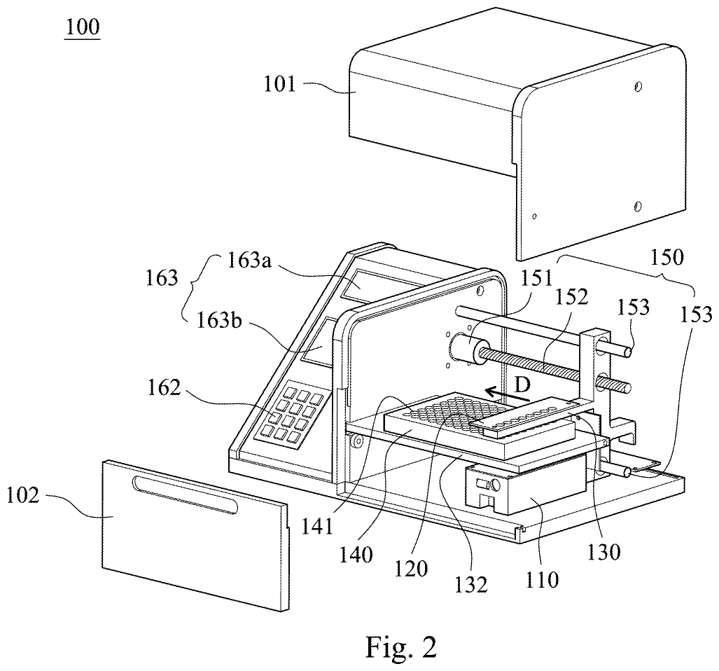

FIG. 1 is an appearance schematic view of an optical measuring device 100 according to an embodiment of the present disclosure, and FIG. 2 is an exploded view of the optical measuring device 100 according to the embodiment of FIG. 1. In FIGS. 1 and 2, the optical measuring device 100 includes a light source 110, an optical sensing module 120, a positioning frame 130, a carrier 140 and a linking device 150. The light source 110 and the optical sensing module 120 are relatively disposed on the positioning frame 130. The linking device 150 is connected to the positioning frame 130 and is for linking up with the light source 110 and the optical sensing module 120 to move along a predetermined direction D. The light source 110 emits a light toward a side of the carrier 140, and passes a plurality of containing concaves 141 of the carrier 140 to form a plurality of measured lights, and each of the optical sensors 121 of the optical sensing module 120 relatively receives each of the measured lights. Therefore, when different measured objects are contained in each of the containing concaves 141, such as differently unknown concentrations of solutions, each of the optical sensors 121 can receive the measured lights passing through the containing concaves 141, and the luminosity value can be read, so as to further estimate and measure the concentrations of each solution. It should be mentioned that the carrier 140 includes a plurality of the containing concaves 141, which are arranged into a plurality of hole rows along the predetermined direction D, and the light source 110 and the optical sensing module 120 are linked with the linking device 150 to move to the relevant position of each of the hole rows, and each of the measured lights can be received relatively. Therefore, the optical measuring device 100 of the present disclosure can be used to measure a plurality of the measured objects meanwhile and the measurement efficiency can be efficiently enhanced.

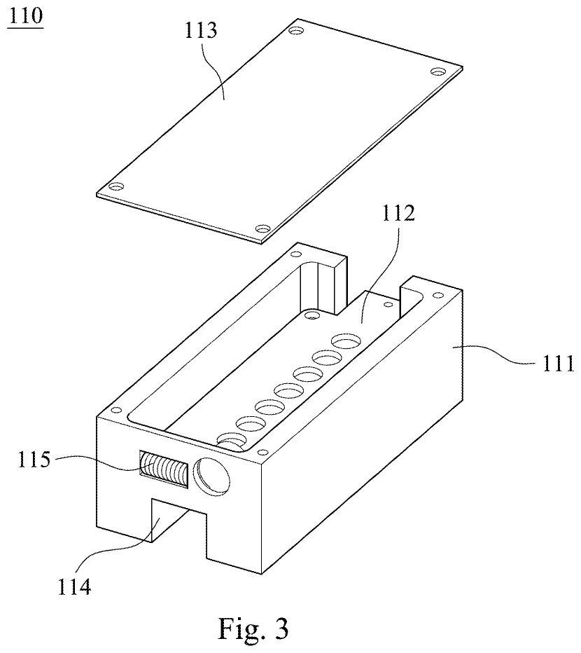

In detail, FIG. 3 shows an exploded view of the light source 110 according to the embodiment of FIG. 1. In FIG. 3, the light source 110 can be a LED light card, and the LED light card includes a containing base 111, a LED unit 112 and a diffuser plate 113. The containing base 111 has an opening (its reference numeral is omitted), the LED unit 112 is detachably disposed in the containing base 111, and the diffuser plate 113 detachably covers on the opening of the containing base 111. The direction of the light emitted from the LED unit 112 can be controlled by the diffuser plate 113, so that the light evenly enters into each of the containing concaves 141 of the carrier 140 to avoid uneven distribution of the light intensity which would affect the detection accuracy. Moreover, the LED unit 112 and the diffuser plate 113 are detachably disposed on the containing base 111, so that users can change different LED units 112 on demand so as to change the wavelength of the light emitted from the light source 110 for providing the detecting light sources with different wavelengths as required. In FIG. 3, the LED unit 112 is a LED light bar, but the present disclosure is not limited thereto. Furthermore, the LED light card can further include an adjusting element 115, and the adjusting element 115 is disposed in the containing base 111 and electrically connected to the LED unit 112. Therefore, the light intensity of the LED unit 112 can be appropriately adjusted under the different detection conditions and situations so as to expand the application range of the optical measuring device 100.

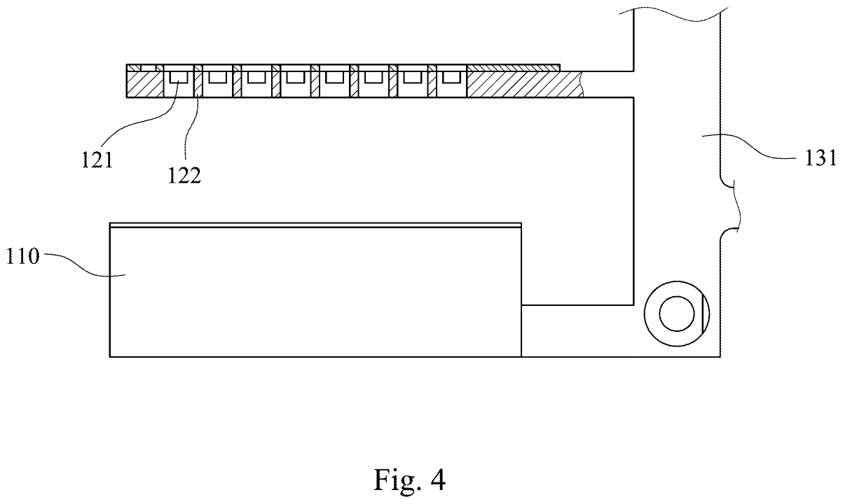

FIG. 4 shows a schematic view of the light source 110, the optical sensing module 120 and the positioning frame 130 according to the embodiment of FIG. 2. In FIG. 4, the positioning frame 130 includes a U-shaped support 131, the light source 110 and the optical sensing module 120 are relatively disposed on two sides of the U-shaped support 131. In FIG. 3, the containing base 111 can further include an embedded structure 114, and the embedded structure 114 can be detachably embedded to the U-shaped support 131, which is further favorable for replacement of the light source 110. The optical sensing module 120 includes a plurality of the optical sensors 121. The optical sensors 121 can be a photodiode, but the present disclosure is not limited thereto.

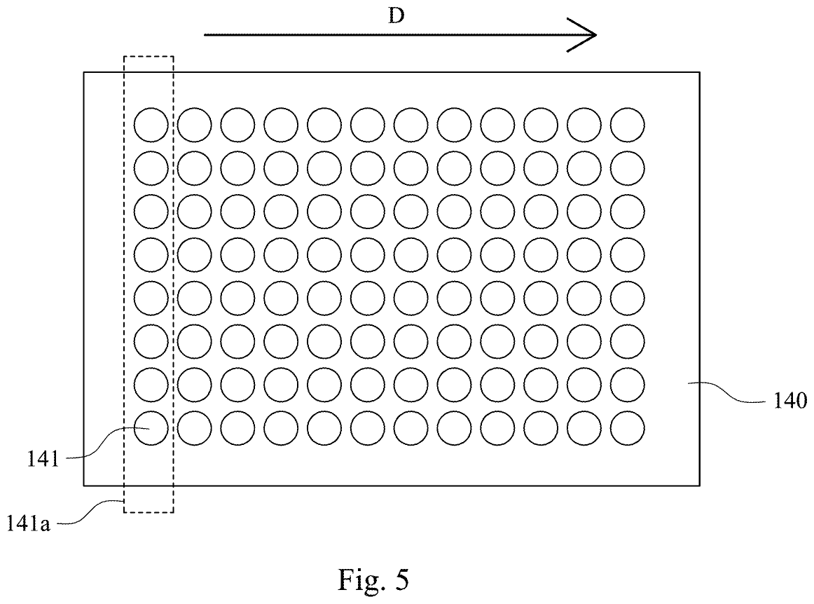

FIG. 5 shows a schematic view of the carrier 140 according to the embodiment of FIG. 2. In FIG. 5, the carrier 140 includes a plurality of hole rows (in FIG. 5, one of the hole rows 141a is labelled), and each of the hole rows 141a is arranged along the predetermined direction D. Each of the hole rows 141a includes a plurality of the containing concaves 141 for containing the measured objects, respectively. In FIGS. 2, 4 and 5, when the optical sensing module 120 is moved by the linking device 150 above the hole rows 141a which is to be sensed, and each of the optical sensors 121 corresponds to each of the containing concaves 141 for receiving each of the measured lights from each of the containing concaves 141, respectively. Therefore, a number of the optical sensors 121 of the optical sensing module 120 is the same as a number of the containing concaves 141 of each of the hole rows 141a. In FIGS. 2, 4, and 5, a number of the containing concaves 141 of each of the hole rows 141a is eight, relatively, a number of the optical sensors 121 is eight, but the present disclosure is not limited thereto.

Moreover, the optical measuring device 100 can further include a carrier frame 132. The carrier frame 132 is located between two inner sides of the U-shaped support 131, and the carrier 140 is detachably connected to the carrier frame 132, so that the light source 110 and the optical sensing module 120 can move at two sides of the carrier 140.

Furthermore, the positioning frame 130 can further include a plurality of interval holes 122, and each of the interval holes 122 surrounds each of the optical sensors 121. In order to avoid each of the optical sensors 121 receiving the light except from each of the measured lights of the corresponding containing concave 141, such as the light from the neighbor containing concaves 141, which would affect the measurement accuracy. Therefore, the arrangement of the interval holes 122 is favorable for blocking external light except corresponding the measured lights, and the measurement accuracy of each of the optical sensors 121 can be increased.

In FIG. 2, the linking device 150 can include a motor 151 and a screw rod 152. The positioning frame 130 is connected to the screw rod 152, and an end of the screw rod 152 is driven by the motor 151 for linking with the positioning frame 130. The screw rod 152 is disposed along the predetermined direction D for driving the positioning frame 130 displaced toward the predetermined direction D. According to the embodiment of FIG. 2, the motor 151 can be a stepper motor, but the present disclosure is not limited thereto. Therefore, the motor 151 and the screw rod 152 can be signally controlled to drive the positioning frame 130, and the light source 110 and the optical sensing module 120 can be moved to two sides of the designated hole rows 141a for measurement. Furthermore, the linking device 150 can further include at least one auxiliary track 153 which can cooperate with different type of the positioning frame 130, and the positioning frame 130 is further connected to the auxiliary track 153 so as to further stably displace. According to the embodiment of FIG. 2, a number of the auxiliary track 153 of the optical measuring device 100 is two, but the present disclosure is not limited thereto.

In FIG. 1, the optical measuring device 100 can include a cover 101, and the aforementioned elements can be disposed in the cover 101. The cover 101 can include a shutter 102, so that it is favorable for disposing and replacing the measured objects, and further favorable for the disposition of the light source 110 or the inspection and maintenance of other elements. A side of the shutter 102 is pivotally connected to the cover 101, so that it is convenient for the users to replace the measured objects and inspect the condition of elements inside of the cover 101.

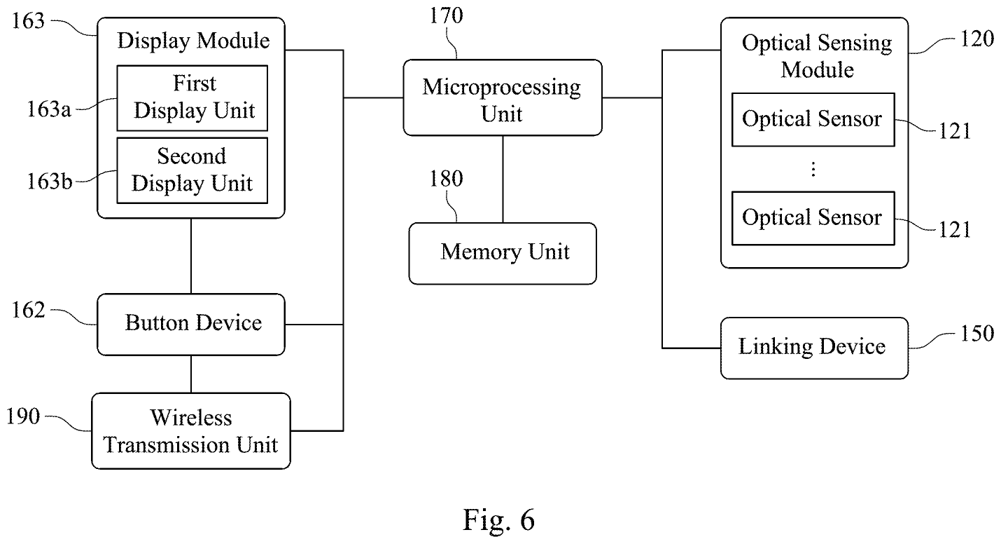

FIG. 6 shows a system block diagram of the optical measuring device 100 according to the embodiment of FIG. 2. In FIGS. 1 and 6, the optical measuring device 100 can further include a button device 162, a display module 163, a microprocessing unit 170 and a memory unit 180. In detail, the button device 162 and the display module 163 are disposed on the outside of the cover 101, and the microprocessing unit 170 and the memory unit 180 are disposed in the cover 101. The button device 162 is signally connected to the linking device 150, wherein a control signal can be sent by the button device 162 to the microprocessing unit 170 to be converted, and then transmitted to the linking device 150, so that the linking device 150 can drive the positioning frame 130 to displace, so that the light source 110 and the optical sensing module 120 can be move along the predetermined direction D to two sides of the designated hole rows 141a for measurement. The users can control the light source 110 and the optical sensing module 120 by the button device 162 to move to the designated hole rows 141a for measurement, or to move along the predetermined direction D for measuring every hole row 141a. When the measured lights from the corresponding containing concaves 141 is detected by each of the optical sensors 121, the signal can be outputted into the microprocessing unit 170. The concentrations of the measured objects of each of the containing concaves 141 can be displayed on the display module 163 after the signal calculated and conversed by the microprocessing unit 170. The memory unit 180 is signally connected to the microprocessing unit 170, and the concentrations of the measured objects of each of the containing concaves 141 can be stored in the memory unit 180 to facilitate analysis and application of the data.

In detail, the optical measuring device 100 of the present disclosure utilizes the intensity variation of the light source 110 before and after passing through the measured objects which is measured by the optical sensors 121 to calculate the light intensity transmittance thereof by the microprocessing unit 170, and then further calculate the concentration ratio of the specific composition of the measured objects. For example, the users can add a reagent into a measured solution to measure the concentration of one composition of the measured solution, wherein the reagent may react with the composition to generate the color variation of the measured solution. Moreover, the users can choose the light source 110 which makes the reagent significant changed as the main detection light source, and adjust the light intensity accordingly via the aforementioned adjusting element 115. When the light source 110 and the optical sensing module 120 have not moved to the corresponding hole rows 141a, the light emitted from the light source 110 can be detected first, and an original transmission intensity voltage I₀ is outputted to the microprocessing unit 170, and is stored in the memory unit 180. Then, the measured solutions with the aforementioned reagent is put into the containing concaves 141, the light source 110 and the optical sensing module 120 are moved to two sides of the containing concaves 141, and a transmission intensity voltage I₁ is measured by the optical sensors 121, which can be outputted to the microprocessing unit 170 and stored in the memory unit 180. A transmission T can be further calculated with the following formula (1):

$$T = \frac{{I}_{1}}{{I}_{0}} . \qquad ( 1 )$$

The calculated transmission T can be further displayed on the display module 163 by the microprocessing unit 170. Moreover, the users can obtain a liquid concentration Abs according to the transmission T measured from the optical measuring device 100 with Beer-Lambert Law, as the following formula (2):

Abs=εCL=−log T (2);

wherein, ε is a liquid extinction coefficient which can be a fixed constant for some specific liquids, C is a liquid concentration, and L is a path length of glimmer.

Therefore, the concentration of the certain composition of the measured liquid can be obtained by the optical measuring device 100.

It should be mentioned that in the optical measuring device 100 of FIG. 2, the carrier 140 has a plurality of the hole rows 141a, and each of the hole rows 141a includes a plurality of the containing concaves 141. In FIGS. 2 and 4, the carrier 140 includes twelve hole rows 141a, and each of the hole rows 141a includes the eight containing concaves 141. Therefore, 12×18 kinds of the measured objects can be carried and measured by the carrier 140 at the same time. A number of the containing concaves 141 of each of the hole rows 141a is corresponding to a number of the optical sensors 121 of the optical sensing module 120, which is the number of the optical sensors 121 is eight. Thus, the measured lights from the eight containing concaves 141 can be simultaneously measured by the optical measuring module 120. By such arrangement, it just takes two to three seconds to detect with the optical sensors 121, and it takes less than forty seconds to finish the measurement of all of the twelve hole rows 141a. Therefore, the optical sensing device 100 of the present disclosure provides a highly efficient measurement, and widens the detection range and the application range.

In FIGS. 1 and 6, the display module 163 can include a first display unit 163a and a second display unit 163b, wherein one of the first display unit 163a and the second display unit 163b can be used to display the detection target which is chosen by the users, such as all of the hole rows 141a on the carrier 140 would be detected, or only the specific hole rows 141a would be detected, and the other one of the first display unit 163a and the second display unit 163b can show the measurement result, but the present disclosure is not limited thereto.

Moreover, the optical measuring device 100 of FIG. 6 can further include a wireless transmission unit 190 signally connected to the microprocessing unit 170. By the arrangement of the wireless transmission unit 190, the optical measuring device 100 can directly transmit the transmission or other detection data calculated by the microprocessing unit 170 to users' computers, cellphones or other electronic devices. It is favorable for the analysis and application of data. Certainly, the signal transmission can be transmitted by wire transmission, and the present disclosure is not limited thereto.

In FIG. 1, the cover 101 can further include a switch 161. When the optical measuring device 100 is connected to an external power supply system, the power is turned on or off via the switch 161. The arrangement of the switch and the power are common knowledge in the field of the present disclosure, and will not be described herein.

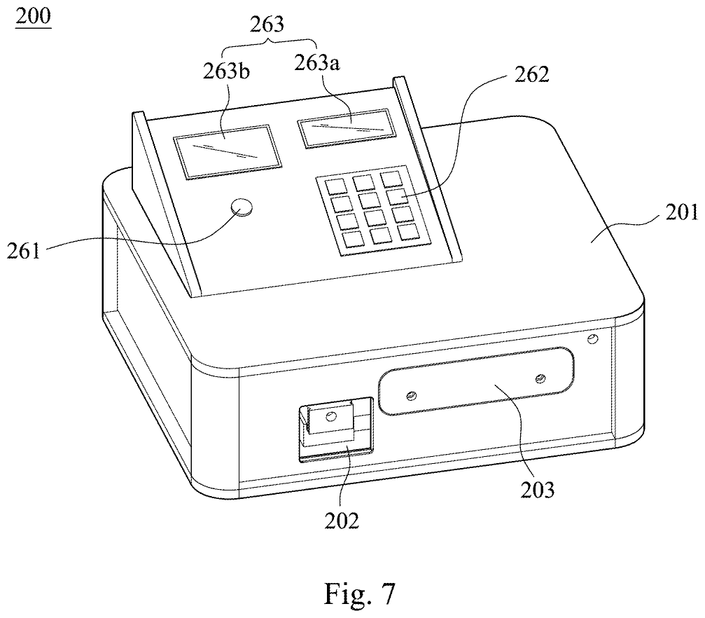

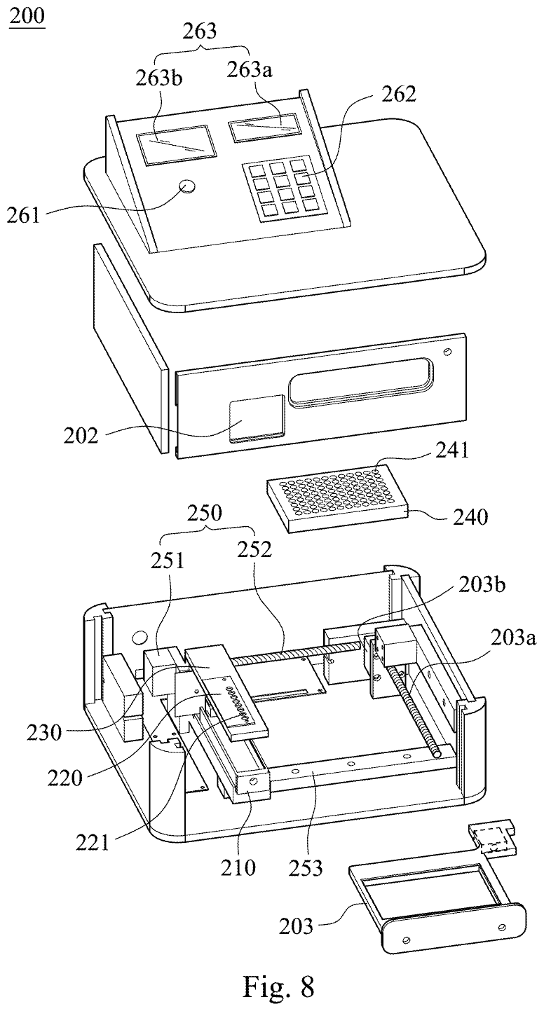

FIG. 7 shows an appearance schematic view of an optical measuring device 200 according to another embodiment of the present disclosure, and FIG. 8 shows an exploded view of the optical measuring device 200 according to the embodiment of FIG. 7. In FIGS. 7 and 8, the optical measuring device 200 includes a light source 210, an optical sensing module 220, a positioning frame 230, a carrier 240 and a linking device 250. The light source 210 and the optical sensing module 220 are relatively disposed on the positioning frame 230. The linking device 250 is connected to the positioning frame 230 and is for linking up with the light source 210 and the optical sensing module 220 along the predetermined direction. The light source 210 emits a light toward a side of the carrier 240, and passes a plurality of the containing concaves 241 of the carrier 240 to form a plurality of the measured lights, and each of the optical sensors 221 of the optical sensing module 220 relatively receives each of the measured lights. Therefore, each of the different measured objects, such as different unknown concentrations of solutions, is contained in each of the containing concaves 241. The measured lights passing through the containing concaves 241 are received by each of the corresponding optical sensors 221 to read the luminosity value, and each of the concentrations of the solutions can be further estimated and measured. It's worth mentioning that the carrier 240 includes a plurality of the containing concaves 241, a plurality of hole rows are arranged along the predetermined direction, the linking device 250 links up with the light source 210 and the optical sensing module 220 to move to the relevant position of each of the hole rows, and relatively receives each of the measured lights. Therefore, the optical measuring device 200 of the present disclosure can be used to measure a plurality of the measured objects meanwhile and efficiently enhance measurement efficiency.

Different from the embodiment of FIG. 2, the linking device 250 includes a motor 251, a screw rod 252 and a slide rail 253 which is for fitting the appearance and size of the positioning frame 230. The positioning frame 230 is driven by the motor 251 and the screw rod 252 to move along the slide rail 253 stably, so that the light source 210 and the optical sensing module 220 can be moved to the predetermined position to measure.

From the appearance, according to the embodiment of FIG. 7, the optical measuring device 200 can include a cover 201, and all of the aforementioned elements can be disposed in the cover 201. The cover 201 includes a switch 261, a button device 262 and a display module 263, and the display module 263 includes a first display unit 263a and a second display unit 263b, wherein the aforementioned elements are the same as the corresponding elements in the embodiment of FIG. 1, and will not be described again herein.

In FIGS. 7 and 8, the cover 201 includes a light source exchanging hole 202, and the light source 210 is a LED light card which is detachably connected to the positioning frame 230 via the light source exchanging hole 202. Therefore, the LED light card can be inserted into the positioning frame 230 along a single direction to have fool-proof function.

Furthermore, the optical measuring device 200 can further include a tray 203 movably disposed on the cover 201, and the carrier 240 can be disposed on the tray 203. By connecting the tray 203 to a screw rod 203a and driving the screw rod 203a through a motor 203b, the tray 203 and the carrier 240 can be moved in or out from the cover 201 for further easily putting the measured objects on the carrier 240.

The details and other elements of the optical measuring device 200 according to the embodiment of FIGS. 7 and 8 are the same as the optical measuring device 100 according to the embodiment of FIG. 1, and will not be described again herein.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An optical measuring device, comprising:
a light source;
an optical sensing module comprising a plurality of optical sensors;
a positioning frame, the light source and the optical sensing module relatively disposed on the positioning frame;
a carrier comprising a plurality of hole rows, and the hole rows arranged along a predetermined direction, wherein each of the hole rows comprises a plurality of containing concaves for containing a measured object; and
a linking device connected to the positioning frame and for driving the light source and the optical sensing module to move along the predetermined direction;
wherein, the light source emits a light toward a side of the carrier, the light passes through the containing concaves to form a plurality of measured lights, and each of the optical sensors receives each of the measured lights.

2. The optical measuring device of claim 1, wherein the light source is a LED light card, and comprises:
a containing base having an opening;
an LED unit disposed in the containing base; and
a diffuser plate detachably covered on the opening.

3. The optical measuring device of claim 2, wherein the LED light card further comprises:
an adjusting element disposed in the containing base and electrically connected to the LED unit.

4. The optical measuring device of claim 1, wherein the positioning frame comprises a U-shaped support, and the light source and the optical sensing module are relatively disposed at two sides of the U-shaped support.

5. The optical measuring device of claim 4, further comprising:
a carrier frame located between the two sides of the U-shaped support, and the carrier detachably connected to the carrier frame.

6. The optical measuring device of claim 1, wherein each of the optical sensors is a photodiode.

7. The optical measuring device of claim 1, wherein a number of the containing concaves of each of the hole rows is the same as a number of the optical sensors.

8. The optical measuring device of claim 1, wherein the positioning frame further comprises a plurality of interval holes, and each of the interval holes surrounds each of the optical sensors.

9. The optical measuring device of claim 1, wherein the linking device comprises:
a motor; and
a screw rod, wherein the positioning frame is connected to the screw rod, one end of the screw rod is driven by the motor and for linking with the positioning frame.

10. The optical measuring device of claim 1, further comprising:
a cover for containing the light source, the optical sensing module, the positioning frame, the carrier and the linking device.

11. The optical measuring device of claim 10, wherein the cover comprises a shutter.

12. The optical measuring device of claim 1, further comprising:
a button device signally connected to the linking device.

13. The optical measuring device of claim 1, further comprising:
a microprocessing unit signally connected to the optical sensors.

14. The optical measuring device of claim 13, further comprising:
a display module signally connected to the microprocessing unit.

15. The optical measuring device of claim 13, further comprising:
a memory unit signally connected to the microprocessing unit.

16. The optical measuring device of claim 13, further comprising:
a wireless transmission unit signally connected to the microprocessing unit.

17. The optical measuring device of claim 10, wherein the cover comprises a light source exchanging hole, the light source is a LED light card, and the LED light card is detachably connected to the positioning frame through the light source exchanging hole.

18. The optical measuring device of claim 10, further comprising:
a tray movably disposed on the cover, and the carrier disposed on the tray.
